(19) United States
(12) Patent Application Publication
(10) Pub. No.: US 2013/0292588 A1
(43) Pub. Date: Nov. 7, 2013

(54) SOLENOID VALVE

(71) Applicant: Buerkert Werke GmbH, Ingelfingen (DE)

(72) Inventors: Uwe-Alexander KRUG, Jagsthausen (DE); Patrick Mohs, Kuenzelsau (DE)

(21) Appl. No.: 13/864,330

(22) Filed: Apr. 17, 2013

(30) Foreign Application Priority Data
Apr. 17, 2012 (DE) 20 2012 003 969.5

(51) Int. Cl. F16K 31/42

(52) U.S. Cl. CPC F16K 31/42
USPC 251/30.01

(57) ABSTRACT

A solenoid valve has a main stage and a pilot stage, wherein the main stage includes a switching element which in the closed condition of the solenoid valve closes a main flow path from a high-pressure side to a low-pressure side and in the open condition of the solenoid valve clears the main flow path. In its closed condition, the pilot stage closes a pilot flow path from the high-pressure side to the low-pressure side and in its open condition clears the pilot flow path. The pilot flow path leads through a control chamber which is in permanent flow connection with the high-pressure side via a control opening. The pressure existing in the control chamber acts on the switching element. The pilot stage includes a coil and a pilot valve element movable by a magnetic field of the coil, which are arranged at the switching element and are moved with the same.

### FIELD OF THE INVENTION

This invention relates to a solenoid valve.

### BACKGROUND

There are known solenoid valves which include a main stage and a pilot stage, wherein opening and closing of the main stage is effected solely by actuating the pilot stage. The pilot stage generally is supported by a servo mechanism, so that for switching the valve only small forces or currents must be applied. The additional pilot stage, however, increases the space requirement of the valve.

### SUMMARY

It is the object of the invention to create a small-sized and easily switchable solenoid valve.

The invention provides a solenoid valve with a main stage and a pilot stage, wherein the main stage includes a switching element which in the closed condition of the valve closes a main flow path from a high-pressure side to a low-pressure side and in the open condition of the valve clears the main flow path, and the pilot stage in its closed condition closes a pilot flow path from the high-pressure side to the low-pressure side and in its open condition clears the pilot control path. The pilot flow path leads through a control chamber which is in permanent flow connection with the high-pressure side via a control opening, wherein the pressure existing in the control chamber acts on the switching element. The pilot stage includes a coil and a pilot valve element movable by the magnetic field of the coil, which are arranged at the switching element and are moved together with the switching element.

The switching element is e.g. a membrane element, i.e. the pressure in the control chamber acts on a membrane. Alternatively, the switching element also can be designed as rigid piston.

The switching element may comprise an elastic membrane and a rigid closing body arranged centrally at the membrane. In the arrangement according to the invention, the pilot stage is miniaturized to such an extent that it can be arranged completely e.g. at or in the closing body. The closing body exclusively is attached to the membrane and is not mounted on the housing. In this way, the stroke of the membrane or the closing body substantially is independent of the stroke of the pilot stage. The overall size of the valve is reduced, since the pilot stage is not placed onto the outside of the valve. Due to the utilization of the medium pressure for supporting the opening and closing of the main stage, the power consumption of the pilot stage can be reduced.

The closing body preferably is shiftably guided in a valve housing, which can be a valve fitting.

According to a further option, the switching element is a rigid piston which in the closed condition of the solenoid valve rests against a valve seat.

The solenoid valve is suitable in particular for water and other hardly corrosive fluids. The high-pressure side forms an inlet of the valve for the fluid, whereas the low-pressure side forms an outlet.

The main flow path preferably does not lead through the control chamber, but exclusively along a first side of the switching element. On this first side of the switching element, the pressure of the high-pressure side acts on the membrane or on the piston, whereas the pressure in the control chamber acts on an opposite second side of the switching element.

The control chamber can be in flow connection with the high-pressure side only via the control opening.

With closed valve and with closed pilot flow path, the control chamber can be filled with fluid, and on clearance of the pilot flow path the fluid flows off from the control chamber. This can mean that the pilot stage substantially is completely surrounded by fluid, in particular by water. In this case, corresponding measures must be taken for the electrical insulation of current-carrying parts.

On opening of the pilot stage, the pressure in the control chamber and thus also the pressure on the second side of the membrane or the piston can be reduced due to fluid flowing off from the control chamber, so that from a predetermined pressure in the control chamber the switching element is lifted from its valve seat and clears the main flow path.

On closing of the pilot flow path, for example by closing an outflow opening of the pilot stage, fluid starts to fill the control chamber, since the control opening remains open. On reaching a predetermined pressure level, the switching element preferably is urged into its closing position on the valve seat and the main flow path thus is closed.

These flow conditions for example can be adjusted in that in the pilot flow path a minimum cross-section of an outflow opening from the control chamber is greater towards the low-pressure side than the minimum cross-section of the control opening. It is essential here that per unit time a smaller fluid volume flows in from the high-pressure side into the control chamber than flows out from the control chamber to the low-pressure side. The exact flow conditions, which among other things determine the opening and closing times of the valve, can be adapted via the cross-sections of the outflow opening and the control opening.

The fluid quantities flowing in and flowing out in absolute terms have an influence on the necessary size and the necessary stroke and thus the power consumption of the pilot stage. It is therefore advantageous to in particular realize the control opening with a cross-section as small as possible.

In one embodiment, the control opening can be formed by a small opening in the membrane, but can also be realized in another component, e.g. a membrane carrier or the closing body. Providing the control opening in the membrane, however, involves the advantage of a simple and inexpensive manufacture. In the second embodiment, the control opening preferably is formed in the piston.

In the closed condition of the pilot stage, the pilot valve element may rest against a pilot valve seat, and in an open condition of the pilot stage is lifted from the pilot valve seat. Moving the pilot valve element, e.g. lifting from the pilot valve seat, can be effected by energizing the coil of the pilot stage. By lifting the pilot valve element from the pilot valve seat, the outflow opening described above is cleared.

The minimum outflow cross-section can be defined by the outflow opening formed by the lifting of the pilot valve element from the pilot valve seat and/or the minimum inflow cross-section can be defined by the control opening.

The control chamber for example is formed between the switching element and a valve cover closing the valve to the outside. The control chamber can be defined by the second side of the membrane, the closing body and the valve cover or by the piston and the valve cover.

To support the closing movement, the switching element can be pretensioned in closing direction by a spring, wherein the spring acts on the switching element in direction of the valve seat of the main stage. The spring is e.g. accommodated in the control chamber and can be arranged between the switching element and the valve cover.

The spring force advantageously is smaller than the force acting on the switching element in opening direction due to the fluid pressure, so that from falling below a predetermined pressure level in the control chamber, the switching element is lifted from the valve seat against the spring force and the main flow path is cleared.

On exceedance of a predetermined pressure level in the control chamber, the switching element however is pressed onto the valve seat with support of the spring force and the main flow path thus is closed.

The solenoid valve according to the invention can be formed both as a normally open valve or as a normally closed valve.

### BRIEF DESCRIPTION OF THE DRAWINGS

FIG. 1 shows a schematic sectional view of a solenoid valve of the invention according to a first embodiment in the closed condition;

FIG. 2 shows a schematic detail view of the control opening of the solenoid valve of FIG. 1;

FIG. 3 shows a schematic detail view of the pilot control mechanism of the solenoid valve of FIG. 1; and

FIG. 4 shows a schematic detail view of a solenoid valve of the invention according to a second embodiment.

### DETAILED DESCRIPTION

FIG. 1 shows a pilot-controlled solenoid valve 10 with a main stage and a pilot stage. In a valve housing a switching element 12 is accommodated, which includes an elastic membrane 13 and a closing body 14 fixed in the center of the membrane 13 and movable with the same. The switching element 12 can close a main flow path for a fluid from an inlet E to an outlet A of the solenoid valve 10 in the closed condition and clear the same in the open condition.

The inlet E of the solenoid valve 10 forms the high-pressure side of the valve and carries a fluid under a high pressure p₁. Water chiefly is used as fluid, but the solenoid valve 10 also can be used e.g. for other hardly corrosive liquids.

In the closed condition of the solenoid valve 10 as shown in FIG. 1, the membrane 13 rests against a ring-shaped valve seat formed in the valve housing. The closing body 14 here is formed in two parts and includes a base part 15 and a holder 42 connected therewith.

The closing body 14 protrudes into the outlet channel, whose upstream front end forms the valve seat 16, and is axially guided in the outlet channel with a sliding fit.

On the inlet side, a ring chamber 18 open towards the inlet E is formed in the valve housing, which on one side is defined by a first side 20 of the switching element 12, so that the fluid pressure p₁ acts on the membrane 13. The pressure p₁ leads to a force which seeks to lift the switching element 12 from the valve seat 16.

The opposite side 22 of the switching element 12 defines a control chamber 24. The further walls of the control chamber 24 are formed by a housing-side valve cover 26, which closes the solenoid valve 10 to the outside.

In the control chamber 24 a spiral spring 30 is arranged, which extends between the valve cover 26 and the switching element 12 at the level of the valve seat 16 and urges the switching element 12 in direction of the valve seat 16 into the closed position.

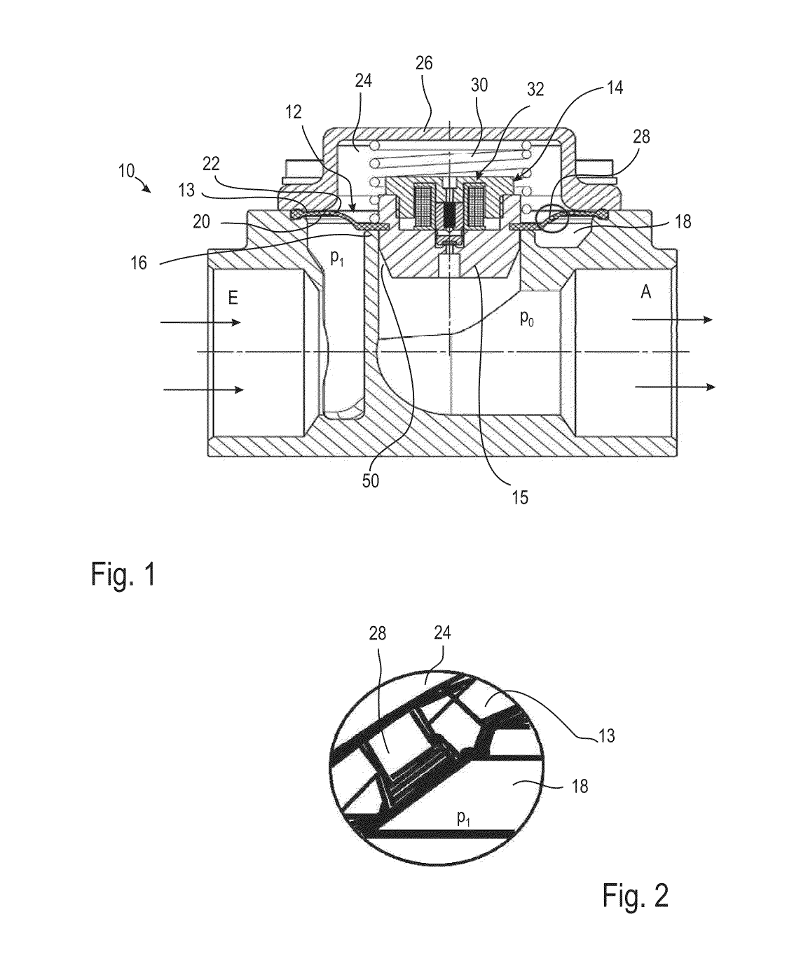

The control chamber 24 is closed towards the surroundings, with the exception of a control opening 28 formed in the membrane 13, which creates a connection from the ring chamber 18 to the control chamber 24 (see FIG. 2). Through the control opening 28, the control chamber 24 is in permanent flow connection with the high-pressure side.

The membrane 13 here is fabricated of a suitable plastic material and is formed so elastic that it is deformed on opening of the main flow path such that the closing body 14 also is lifted from the valve seat 16.

The control opening 28 is formed with a diameter as small as possible and can be formed directly on injection molding of the membrane 13.

To prevent an inadvertent closing of the control opening 28 by particles entrained in the fluid, a filtering or cleaning mechanism can be provided, which prevents clogging of the control opening 28.

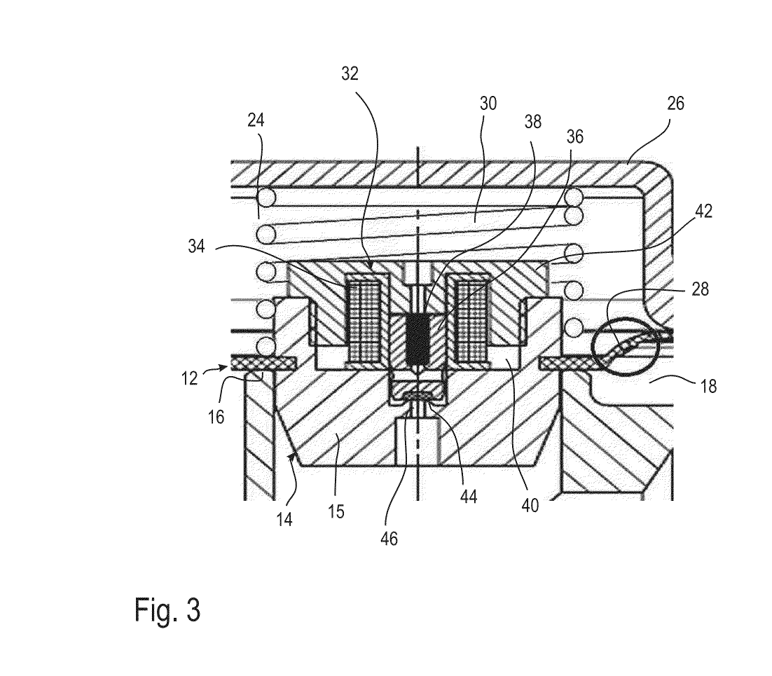

At the closing body 14, a pilot stage 32 is formed. The complete pilot stage 32 including a coil 34, a pilot valve element 36 movable by a magnetic field of the coil 34 and a return spring 38 for the pilot valve element 36 are mounted directly in a cutout 40 of the closing body 14 (see FIG. 3). The holder 42 screwed in as part of the closing body 14 keeps components of the pilot stage 32 in their place.

The electric lines, which lead to the coil 34, extend through the control chamber 24 with enough clearance, in order to permit a movement of the closing body 14. All electric components including the coil 34 are encapsulated such that they are completely electrically insulated with respect to the fluid. In the illustrated embodiment, the coil 34 partly is surrounded by fluid, as it is arranged in the fluid-filled cutout 40.

The coil 34 is sheathed with a plastic material, so that the winding of the coil 34 is electrically insulated. The electric lines likewise can be embedded in the plastic material.

In one variant, the membrane 13 or the entire switching element 12 is formed of an elastomer in one piece with the sheathing of the coil 34. For manufacture, e.g. an injection molding method is employed.

In the closing body 14 a pilot valve seat 44 is formed, against which the pilot valve element 36 rests in the closed condition of the pilot stage 32 and from which the pilot valve element 36 is lifted in the open condition of the pilot stage 32. In the second case the pilot stage 32 is in its open position, and a pilot flow path is cleared.

A number of through holes aligned with each other are formed in the holder 42, in the pilot valve element 36 and in the closing body 14 and form a coherent pilot flow path from the control chamber 24 through the central opening of the coil 34 to the outlet A. The minimum cross-section of this pilot flow path defines an outflow opening 46 at the pilot valve seat 44.

The entire pilot stage 32 is moved with the closing body 14, which forms the valve seat 44 of the pilot stage 32, when the closing body moves from the closed into the open position of the solenoid valve 10 and vice versa.

The valve element 36 and its drive altogether are designed so small that they can be accommodated completely in the closing body 14, without having to substantially increase its dimensions as compared to a closing body of a conventional servo solenoid valve. No large strokes and no high switching force either are required for the pilot stage 32, since merely the outflow opening 46 and a flow path leading through the closing body 14 must be cleared.

The stroke exerted by the closing body 14 on opening of the main flow path is independent of the stroke carried out by the pilot valve element 36 for opening the pilot stage 32.

Besides being arranged on the closing body 14, the pilot stage 32 also might directly be arranged on the membrane 13 or at another suitable point in the control chamber 24.

In the illustrated closed condition of the solenoid valve 10, the coil 34 is currentless, the pilot valve element 36 rests against the pilot valve seat 44 and hence closes the outflow opening 46, and the main flow path is closed, since the membrane 13 and the closing body 14 rest against the valve seat 16. Via the ring chamber 18 and the control opening 28, fluid has flown from the high-pressure side of the inlet into the control chamber 24 and has completely filled the same, so that in the control chamber 24 the pressure p₁ of the high-pressure side exists. Due to the spring force of the spring 30, the switching element 12 remains in the closed position.

For switching the valve into the open position, the coil 34 of the pilot stage 32 is energized, and the pilot valve element 36 (in the position shown in FIGS. 1 and 3) is lifted upwards from the pilot valve seat 44.

Via the pilot flow path now cleared, fluid flows off from the control chamber 24 through the closing body 14 to the outlet A via the outflow opening 46 towards the low-pressure side with the lower pressure p₀.

The minimum cross-section of the outflow opening 46 is chosen distinctly larger than the minimum cross-section of the control opening 28. In general, the fluid quantity flowing off from the control chamber 24 per unit time thus is distinctly larger than the fluid quantity flowing in into the control chamber 24 per unit time. The control chamber 24 thus runs empty after opening of the pilot stage 32. The pressure in the interior of the control chamber 24 therefore is reduced from the initially existing pressure p₁ of the high-pressure side in direction of the pressure p₀ on the low-pressure side.

The spring force of the spring 30 is chosen such that it is smaller than the force which the medium on the high-pressure side exerts on the switching element 12 via the pressure p₁. From falling below a predetermined limit pressure in the control chamber 24, the switching element 12 therefore is pressed into the control chamber 24. The membrane 13 and the control body 14 are lifted from the valve seat 16, and the main flow path is cleared, so that fluid can flow from the inlet E to the outlet A.

In the open position, the closing body 14 either no longer protrudes into the outlet A at all or only with its conical end 50, so that an annular space is exposed.

For closing the solenoid valve 10 the pilot stage 32 is closed, in that the pilot valve element 36 again is lowered onto the pilot valve seat 44 and thus the outflow opening 46 is closed. As a result, the control chamber 24 is filled by fluid flowing in through the control opening 28 due to the pressure difference between the ring chamber 18 and the control chamber 24. From exceedance of a predetermined limit pressure, the force of the spring 30 in addition to the pressure acting in the control chamber 24 on the second side 22 of the switching element 12 is large enough to again press the switching element 12 onto the valve seat 16 and thus close the main flow path.

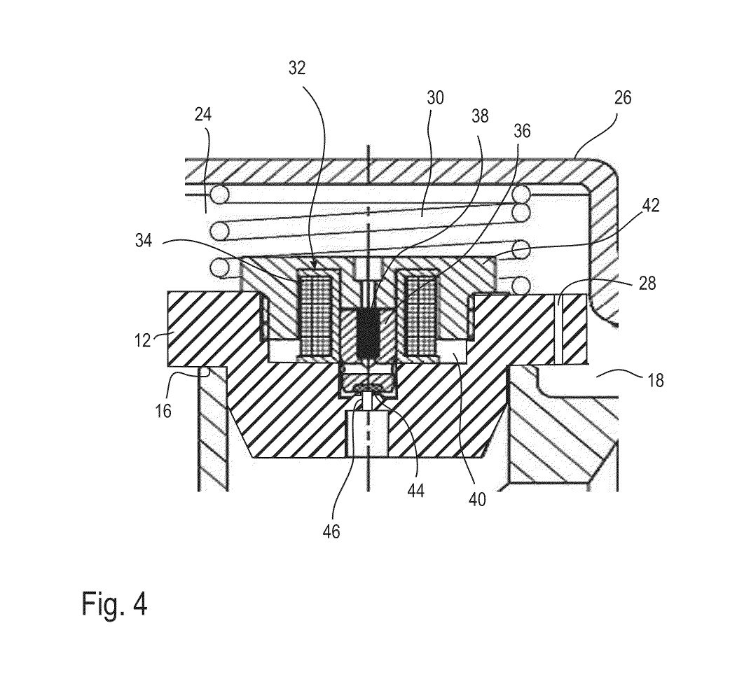

FIG. 4 shows a second embodiment of a solenoid valve. In contrast to the first embodiment, the switching element 12 here is formed by a rigid piston.

Like in the first embodiment, the switching element 12 rests against the valve seat 16 in the closed condition of the solenoid valve 10, whereas in the open condition it is lifted from the valve seat 16 and clears the main flow path.

The inner wall of the valve cover 26 for example can form an axial guideway for the movement of the piston on opening and closing of the solenoid valve 10.

In this embodiment, the control opening 28 is formed in the piston itself.

Here as well, the sheathing of the coil 34 can be injection-molded of a suitable plastic material in one piece with the piston, wherein the electrical feed lines also can be embedded in this component.

1. A solenoid valve with a main stage and a pilot stage, comprising
a main flow path from a high-pressure side to a low-pressure side,
a pilot flow path from the high-pressure side to the low-pressure side,
wherein the main stage includes a switching element which in the closed condition of the solenoid valve closes the main flow path from a high-pressure side to a low-pressure side and in the open condition of the solenoid valve clears the main flow path,
wherein the pilot stage in its closed condition closes the pilot flow path from the high-pressure side to the low-pressure side and in its open condition clears the pilot flow path,
wherein the pilot flow path leads through a control chamber being in permanent flow connection with the high-pressure side via a control opening, and the pressure existing in the control chamber acts on the switching element, and
wherein the pilot stage includes a coil and a pilot valve element movable by a magnetic field of the coil, which are arranged at the switching element and are moved together with the switching element.

2. The solenoid valve according to claim 1, wherein with closed solenoid valve (10) and with closed pilot flow path the control chamber (24) is filled with fluid and on clearance of the pilot flow path the fluid flows off from the control chamber (24).

3. The solenoid valve according to claim 1, wherein in the pilot flow path a minimum cross-section of an outflow opening from the control chamber to the low-pressure side is greater than a minimum cross-section of the control opening.

4. The solenoid valve according to claim 1, wherein in the closed condition of the pilot stage the pilot valve element rests against a pilot valve seat and in an open condition of the pilot stage is lifted from the pilot valve seat.

5. The solenoid valve according to claim 4, wherein the minimum outflow cross-section from the control chamber is defined by an outflow opening formed by lifting of the pilot valve element from the pilot valve seat.

6. The solenoid valve according to claim 1, wherein the minimum inflow cross-section into the control chamber is defined by the control opening.

7. The solenoid valve according to claim 1, wherein the control chamber is formed between the switching element and a valve cover closing the valve to the outside.

8. The solenoid valve according to claim 1, wherein the switching element is pretensioned in closing direction by a spring.

9. The solenoid valve according to claim 8, wherein the spring is accommodated in the control chamber.

10. The solenoid valve according to 8, wherein the spring force is smaller than the force acting onto the switching element in opening direction due to the fluid pressure.

11. The solenoid valve according to claim 1, wherein the switching element includes an elastic membrane and a rigid closing body attached to the membrane, which carries the pilot valve element and through which the pilot flow path extends.

12. The solenoid valve according to claim 1, wherein the switching element includes an elastic membrane which in the closed condition of the solenoid valve rests against a valve seat, wherein the control opening is formed in the membrane.

13. The solenoid valve according to claim 1, wherein the switching element is a rigid piston which in the closed condition of the solenoid valve rests against a valve seat, wherein the control opening is present in the piston.
